(19) United States
(12) Patent Application Publication
(10) Pub. No.: US 2026/0048325 A1
(43) Pub. Date: Feb. 19, 2026

(54) INTERACTIVE CONTENT MODIFICATION BASED ON IN-CONTENT EVENTS AND USER ENGAGEMENT

(71) Applicant: Adeia Guides Inc., San Jose, CA (US)

(72) Inventors: Jean-Yves Couleaud, Mission Viejo, CA (US); Charles Dasher, Lawrenceville, GA (US); Aldis Sipolins, Somerville, MA (US)

(21) Appl. No.: 18/806,414

(22) Filed: Aug. 15, 2024

(51) Int. Cl. A63F 13/537; G06Q 30/0251; G06T 19/00

(52) U.S. Cl. CPC A63F 13/537; G06Q 30/0269; G06T 19/006; G06T 2200/24; G06T 2210/36

(57) ABSTRACT

In an interactive media system, for example, in a video game or extended reality (XR) environment, interactive media event information may be received. An interactive media satisfaction value may be determined based on one or more interactive media events received. For example, the event may be scoring a point by the user. When the interactive media satisfaction value is determined to be high, supplemental content with more upbeat themes may be selected for display in the interactive media user interface, while supplemental content with more negative themes, or more comfort-oriented or escapist themes may be selected when the satisfaction value is low. A user engagement metric may also be determined and used for timing, locating, and selecting a mode for presenting the supplemental content.

### BACKGROUND

Disclosed are systems and methods for modifying a user interface or experience of interactive media content or application, such as a video game or an immersive, extended reality (XR) environment, by providing supplemental content. More particularly, supplemental content may be provided in response to a determination of a user performance or satisfaction value and/or based on a user engagement metric.

### SUMMARY

A technological problem that arises with software use, including games and the like, is the need for information appropriate to the experience of the user throughout the user's course of interaction with the game or other software application. Supplemental content, such as media content or various types of supplemental content, may be a source of additional information and/or may be useful for a user, and may include URL links or other avenues of interaction with content. However, bombarding a user with information, graphics, or supplemental content throughout the user's interaction with a game or other software application, will likely leave the user frustrated and the user may stop using the software. Information, including supplemental content, that is inappropriate to the mood or feelings of the user, or that is not fully perceptible or processable by the user represents a misuse of computer resources, including a waste of server and client processor time, memory, network resources, and energy. Computing and network resources, and energy may be expended to generate and transmit the supplemental content without any benefit to the content provider or the user.

In fact, superfluous information that is presented to the user—that is, information that is unsuitable, unhelpful, or resented by the user at the time it is presented—may interfere with proper use of the software, and may be a distraction to the user from the software application or the interaction with the game. Such inappropriate supplemental content, or supplemental content displayed at inappropriate times, may make the user more resistant to consuming information presented. For example, if the supplemental content is provided during a scene or portion of interactive media, interactive content, interactive application or the like, such as a game in which the user is likely to be uninterested and/or too visually or otherwise occupies to take full notice of the supplemental content, then the user is likely to ignore the prompt, and an opportunity for user engagement is missed. Opportunities for providing content useful for the user may be lost if the supplemental content is inappropriate at the time that the user encounters it.

A related technological problem is the need to quantify the likely feelings, mood or satisfaction of the user in response to the user's performance in the game or other events in the game. Often, such information about the satisfaction of the user in real time and/or user engagement in real time at various points in the course of user interaction with the game is not quantified and, therefore, may be lost to the system.

A technological solution described herein is to select information, including supplemental content, at various times in the game, or in the course of use of other software application, taking into account the likely feelings, mood or satisfaction of the user with the game. The user may experience feelings of joy, a sense of accomplishment, a sense of having failed, frustration, or the like (sometimes referred to as user satisfaction), in response to in-game performance or in response to in-game events. Based on the identification of such user performance or occurrence of other software events, a metric of user satisfaction may be determined. Supplemental content may be selected in accordance with the user satisfaction value or metric so determined. Positive supplemental content—entailing positive emotions or upbeat content or the like, may be selected, or negative supplemental content—entailing criticism of competing products, concerns about the absence or nonuse of a product or the like may be selected at a given time in the course of user interaction with the application, according to the user satisfaction value or metric.

In an embodiment, the satisfaction value may be determined and tracked in real time at many points or continuously throughout a game or match or other software session. The game may compute a relatively higher satisfaction value the first time a user attains a level in a game or achieves a new personal best score, and may be a relatively lower value after a successful repeat performance. The satisfaction value may be positive or trend positively for a portion of the game during which the user performs well, or encounters a favorable event, even if overall performance in that game or match is poor. Conversely, the satisfaction value may be negative or trend negatively for a portion of the game during which the user performs poorly, or encounters an unfavorable event, even if overall performance in that game is good.

In an embodiment, a real time metric of user engagement with the game or other software may be determined based on how much of the user's attention is likely to be occupied by the interaction with the game or other software. This metric may be determined, for example, based in part on such factors as the level of difficulty of the game, the role of the player controlled by the user, the number of user inputs/commands received recently by the system, the success of the user in meeting in-game challenges, the rapidity of user eye, head, or hand movement, or the like.

Based at least in part on the user engagement metric, supplemental content may be shown or displayed. In addition, or instead, an impression count for a displayed supplemental content item may be adjusted based on the engagement metric. For example, when the user engagement metric with the game is high, the impression count for displayed supplemental content may be adjusted down or discounted. Or, when the user engagement metric with the supplemental content being displayed is high, for example, when an avatar controlled in the game by the user is determined to be standing at, near, or in close proximity to, a display of an advertisement, the impression count for the advertisement may be adjusted up or incremented.

A method, system, apparatus, non-transitory computer-readable medium, and means for implementing the method are disclosed for presenting supplemental content. A method may include, for instance, by way of illustration: receiving, based on an interactive media event, interactive media event information for interactive media displayed at a graphical user interface; computing, by processing circuitry, an interactive media satisfaction value based at least on the interactive media event determined in the interactive media event information; selecting, by the processing circuitry, based at least in part on the interactive media satisfaction value, a first supplemental content item, wherein positive supplemental content is selected as the first supplemental content when the interactive media satisfaction value is determined to be high, and negative supplemental content is selected as the first supplemental content when the interactive media satisfaction value is determined to be low; and generating for display at the graphical user interface the selected first supplemental content item after the interactive media event.

For example, the first supplemental content may be output by the graphical user interface in the interactive media display of the graphical user interface. The graphical user interface may be provided by an extended reality (XR) device in an XR game.

The interactive media satisfaction value may be determined based at least in part on a previous user encounter with the interactive media event. For example, a user profile may be accessed to determine whether this user has accomplished this result previously, and if so, how recently. A first time user may be more thrilled or pleased with a new accomplishment, and so the satisfaction value may be a higher value. In an embodiment, the satisfaction value may be a percentage of overall possible satisfaction, for example, with 100% representing the highest satisfaction, instead of a scalar value.

The positive supplemental content may be selected as the first supplemental content when the interactive media satisfaction value is determined to be trending higher for at least a threshold period of time or by at least a threshold satisfaction amount or percentage.

The supplemental content may be timed according to future predicted events in the interactive media. Based on the interactive media game event, a future game event may be predicted as being likely to occur. For example, the interactive media system may determine that the player is scoring points rapidly in a game and is about to complete a level. The interactive media system may determine also that, upon the occurrence of the future game event, the satisfaction value is likely to reach a first value higher than a current value. For example, the satisfaction value may reach a local maximum. In this case, the generating for the display the supplemental content may be delayed until the satisfaction value reaches the first value.

Also contemplated is the use of a user engagement metric to control timing and/or mode of display of the supplemental content. Based at least on the interactive media event, the interactive media system may determine an area of user action in a graphical interface of the interactive media. This area of user action may be a target one or more players are focused on.

Based at least on an interactive content role of a first user (e.g., the user is a shooter at the target or is otherwise likely to be looking at or engaged with the target), an engagement metric of the first user with the area of user action may be determined. For example, if the user's entire task in the interactive media world is to shoot at the target, and making the shot takes significant concentration, then the engagement metric may be high. The supplemental content may be generated for the display in a first mode, according to the engagement metric of the first user determined, at the area of user action. For example, the first mode may be a display of a simplified version (e.g., few written words) of the supplemental content. In addition, or instead, the interactive media system may decide to postpone display of the supplemental content until such time as more of the attention of the first player is available to focus on the supplemental content. This may depend, for example, on whether there is “real estate” in the interactive media for displaying the supplemental content right on/behind/near/in front of, et cetera, the area of user action.

Based at least on an in-interactive content role of a second user, an engagement metric of the second user with the area of user action may be determined. For example, the second user may be engaged in an entirely different task in the game, and thus the second user's engagement metric may be quite different from that of the first user. The supplemental content may be generated for the display in a second mode, according to the engagement metric of the second user. For example, the display of the second mode may include more or less detail, words, sounds, speech, or higher or lower resolution of the supplemental content than the display of the first mode.

The first and second users may be playing a multiplayer game accessing the game using different devices. They may be in the same or different physical spaces. For example, in the same physical space, each player may be looking at a split screen version, with one player looking at a first half or portion of the screen and a second player looking at a second half or portion. For this reason, for example, the supplemental content may be generated for the display in the first mode to be viewed via the first device by the first user but not via a second device, and the supplemental content may be generated for the display in the second mode to be viewed via the second device of the second user but not via the first device.

Also contemplated is a computer implemented method, system, apparatus, non-transitory computer-readable medium, and means for implementing the method for presenting supplemental content. A method may include, for instance, by way of illustration, receiving user progress data based on events associated with user interaction with interactive content; computing at least one user satisfaction value based at least on the user progress data generated for a first time period; based on the at least one user satisfaction value, identifying a second time in the interactive content subsequent to the first time period, for inserting supplemental content; and causing display of the supplemental content at the second time in the interactive content.

By way of example, the interactive content may be or may include a video game. The supplemental content may be displayed in the video game by a graphical user interface. For example, the interactive content may be rendered via a graphical user interface provided by an extended reality (XR) device.

The user satisfaction value may be determined based at least in part on at least one game event generated at least in part in reaction to user performance in the video game, or based on several game events generated over a period of time. The user satisfaction value may include, or may be calculated based on, a plurality of values. A trend in the plurality of user satisfaction values may be determined, and the identifying of the second time for inserting the supplemental content may be based at least on the trend.

The interactive content may be a video game, and the method may also include: predicting, based on an event in the video game, that a future game event is likely to occur; determining that, upon the occurrence of the future game event, a second user satisfaction value, for example, a local high, is likely to be reached; and delaying the causing the display of the supplemental content until the user satisfaction value reaches the second user satisfaction value.

Based at least on determining that the user satisfaction value is below a threshold value, other or additional types of supplemental content may be selected, for example, comfort-themed, food-themed, or escapist supplemental content.

In such a method, based at least on an interactive content event, an area of user action in the interactive content may be determined, for example, an area of the screen where a player's attention is focused. Based at least on an interactive content role of a first user, for example, the player is shooting at an area of the screen, an engagement metric of the first user with the area of user action may be determined, and the supplemental content may be caused to be displayed in a first mode, according to the determined engagement metric of the first user with the area of user action. The interactive content may be rendered on a first device and on a second device, and based at least on an interactive content role of a second user interacting with the interactive content via the second device, an engagement metric of the second user with the area of user action may be determined. The supplemental content may be caused to be displayed in a second mode on the second device according to the determined engagement metric of the second user.

For example, the display in the second mode may be more detailed or in higher resolution of the supplemental content than the display on the first device of the supplemental content in the first mode.

Also, in such a method, based at least on an interactive content event, a general engagement metric for user attention to the interactive content may be determined. For example, it may be determined that the user is playing a game which the user is driving on a road and the player's awareness at areas other than the road is likely to be very limited. Based at least on the general engagement metric, the second time for the inserting of the interactive content may be delayed, at least for this user.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A-1H illustrate examples of interactive media event-driven supplemental content selection, in accordance with some embodiments of this disclosure;

FIG. 2 illustrates an example of user satisfaction value or metric computation based on interactive media events, in accordance with some embodiments of this disclosure;

FIG. 3 illustrates an example of user satisfaction value or metric curve and examples of points in time at which supplemental content is inserted, in accordance with some embodiments of this disclosure;

FIG. 4 illustrates an example of determining timing and mode of supplemental content presentation based on user engagement with interactive media, in accordance with some embodiments of this disclosure;

FIGS. 5A and 5B illustrate an example of selection of supplemental content for display and for suppression based on user engagement with the interactive media interface, in accordance with some embodiments of this disclosure;

FIG. 6 shows an inventory or “backpack” of in-game items possessed by the player at a point in time in the game, and real-life items that may be purchased and that match a style of various in-game items, in accordance with some embodiments of this disclosure;

FIG. 7 illustrates an example of a computer system for implementing methods described herein, according to an aspect of the disclosure;

FIG. 8 illustrates a system including a server connected to a database in communication with other nodes via a network, according to an aspect of the disclosure;

FIG. 9 is a flowchart showing an example of a process for timing display of supplemental content, in accordance with some embodiments of this disclosure; and

FIG. 10 is a flowchart showing an example of another process for selecting and timing display of supplemental content, in accordance with some embodiments of this disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

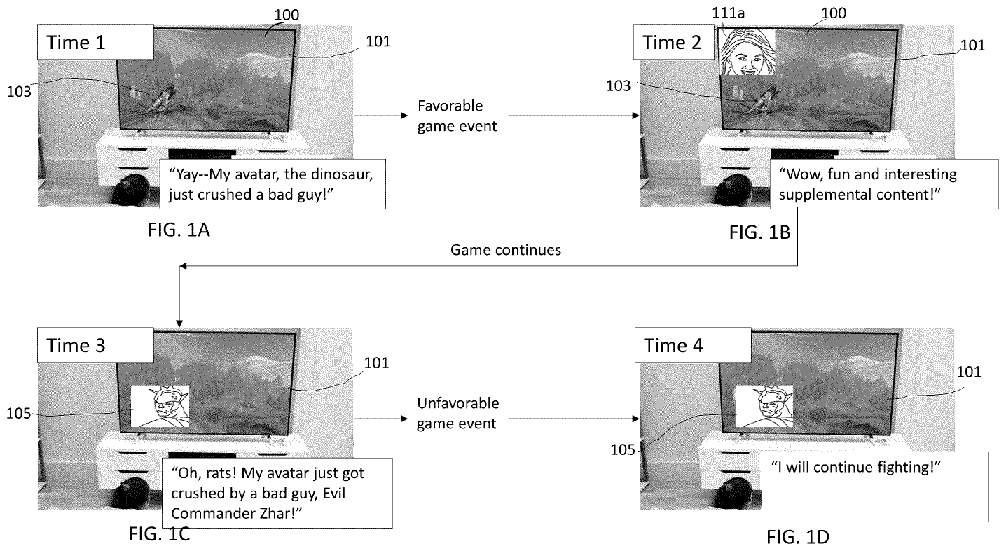

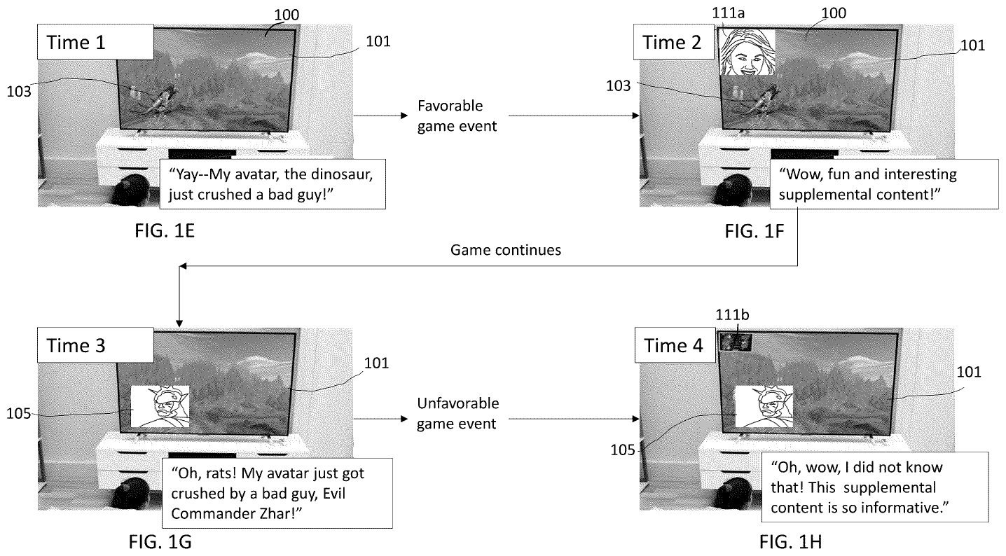

FIGS. 1A-1H show a progression in the use of interactive media, illustrated in this example as a video game played on user equipment 100. Generally, the terms interactive content,” “interactive media,” or “interactive application” may mean or include a video game or other internet content (e.g., streaming content, downloadable content, webcasts, etc.), video clips, audio content, playlists, websites, electronic books, blogs, social media, computing device applications, and/or any other media or multimedia, and/or combination of the above. User equipment 100 may comprise for example, a television and/or may include an integrated display, e.g., on a smartphone or tablet, a gaming console or other gaming platforms or hardware, extended reality (XR) equipment, including, for example, a head-mounted device (HMD). In response to user performance, or to other in-game events, a user satisfaction value is a calculated. The satisfaction value, a change in the satisfaction value, or a rate of change in the satisfaction value, may be an indication, quantification, or prediction of the user's mood or feeling state (in other words “satisfaction”) in response to recent, the most recent, or preceding game event(s). Generally, a user may be less receptive to or engaged with the presentation of supplemental content when the user is performing poorly, struggling or losing for reasons external to his/her performance, and content providers, such as advertisers, may wish not to associate in the user's mind their content, brands, or products with such moments or times. Also, a user may be more likely to make a purchase when in a good mood, e.g., when an associated satisfaction value is relatively high or increasing from a relative or local minimum. Based on the user satisfaction value, various types of supplemental content 111 are selectively and dynamically displayed.

FIG. 1A illustrates that an avatar 103 (e.g., a dinosaur) displayed by the graphical user interface 101 has just defeated a boss or other character in the game. The system may classify this as a favorable in-game event. Based on this game event, the system may set a satisfaction value for this point in the game.

In an embodiment, each game event may be scored on a scale, such as by way of non-limiting example, from zero to 16. A favorable game event may generally relate to achieving a goal or accomplishing a task, for example, defeating a boss or other mob, winning a game or minigame, evading a trap, finding treasure, building a vehicle, completing a game level, reaching a new level or tier in the game, scoring a goal or point, earning in-game points, reaching a point tally, coming in first (or second or third), taking a shot on goal, evading a defender or mob, making a correct prediction, placing a winning bet, preventing an opponent from doing any of the foregoing, a combination of two or more of the foregoing, or the like. The game may classify some game events as unfavorable, and a relatively lower satisfaction value may be computed for such events. Such events may include, for example, failing to attain one or more favorable game events (such as the illustrative examples above), being destroyed, falling into a trap, failing to attain the next level, losing a fight, losing a game, having a goal or point scored against, a combination of the foregoing, or the like.

In an embodiment, each such favorable event may have a prestored numerical value. Based on such a numerical value, a satisfaction value may be computed in several ways. In an implementation, the satisfaction value is additive and may increase throughout the game in response to favorable events in the game and may decrease in response to unfavorable events. The more favorable the game event, the greater the increase in the satisfaction value will tend to be at a corresponding point in the game, but the satisfaction value may depend, at least in part, on other game factors. According to an embodiment, determining the timing of supplemental content placement may be based on a rate of change of the satisfaction value. As the player performs well or gets lucky in the game, or as an opponent in the game does poorly, the player's satisfaction value may increase at a faster rate. As the player performs poorly, unlucky game events occur, or an opponent does well, the satisfaction value may decrease at a faster rate, or in some implementations, may stagnate or even increase at a slower rate.

Supplemental content may be inserted at relative maximum satisfaction values in the game. Supplemental content may be inserted at time points in the game based on the trend in the satisfaction value. For example, when the trend indicates that the satisfaction value is increasing at a rate faster than a previous rate, this may be interpreted as the user is performing well. This may be the time for inserting supplemental content.

Supplemental content may be any content that may be provided as an output to accompany the interactive content or other primary content, and may be related or unrelated thematically or otherwise to the interactive content. For example, the supplemental content asset may be related based on similar subject matter, tempo, or any other suitable relationship to the portion of the interactive content immediately preceding, accompanying or following display of the supplemental content or to the interactive content as a whole, or may not be directly related to the interactive content. The supplemental content may be an advertisement for a product, such as a good or service. The providing of supplemental content may be performed by an application running on a user device or an interactive media guidance application, for example, running on a remote server.

Based on the favorable game satisfaction value, as shown in FIG. 1B, supplemental content 111a may be provided as part of the graphical user interface 101. Supplemental content may comprise text, graphics, video, or any other visual (and/or audio) depiction of information, e.g., an advertisement, a website or URL, a barcode, auxiliary information or auxiliary videos related to a particular product or service, such as, for example, a recommendation for a product or service. For example, supplemental content may be related to a promotion, sale, coupon, discount, newly available product, wish list of the user, or any other information the advertiser wishes to inform the user about to entice him or her to purchase goods or a service. The supplemental content may be displayed overlaid on one or more game graphics. Supplemental content 111a may include a representation of a person expressing approval of the player's performance (“well done”), feedback about the accomplishment (“only three out of 10 players reach this level”) or may be an advertisement that draws on positive emotions. Positive advertising or other positive supplemental content may focus on appealing to desirable emotions or outcomes, such as peaceful feelings, gratitude, or happiness and associating products or brands with such emotions. The supplemental content may also recommend similar interactive media, such as a game that appeals to a similar demographic as the demographic of the user (e.g. retrieved from a user profile), appeals to a similar demographic as the demographic of average users of the game, media content, such as music or movies that are upbeat or fast paced, involves similar types of skills as those used in the game, involves similar types of skills as those used for the task just completed or the goal just achieved in the game, or may promote or provide a glimpse of upcoming aspects of the game. For example, the supplemental content 111 may show events that may occur in a further portion or at a higher level of the game that the player may hope to reach.

FIG. 1C illustrates that as the game continues the player may encounter an unfavorable game event for example, in this example, the player's avatar 103 gets crushed or destroyed or stunned by a villain, shown as graphic 105. This unfavorable game event may be translated to a decrease or no change in the satisfaction value.

The unfavorable game event may be a reflection of the player's in-game performance. In an embodiment, the unfavorable game event or outcome may occur independent of actions by the player. In an embodiment, the unfavorable game event or outcome may occur in response to player actions or performance, or partially in response to player actions or performance. In response to such an event, the satisfaction value may tend to be calculated depending on the severity of the game event.

FIG. 1D shows that in response to no change, or only a modest change, in the satisfaction value, at Time 4, no supplemental content may be displayed.

FIGS. 1E-1H show the same time series with the same user and the same in-game events as in, respectively, FIGS. 1A-1D. However, according to this implementation, as shown in FIG. 1H, negative supplemental content 111b may be selected for display to the user based on no increase or a decrease in the satisfaction value. The negative supplemental content 111b may include negative advertising. Negative advertising tends to show that a product of service is better than another product or service, such as a competing product or service, by explaining negative features or drawbacks of the other product of service, or attempts to convince people to stop taking a specific action or to raise awareness about an important situation. Based on the satisfaction value, the game may offer a consoling message to the user, may offer a tip for how to deal now or in the future with this or similar situations in the game, may be an instructional video or other such content that provides specific guidance for this or other situations in the game. In another example, a brand may be running negative or attack ads such as political campaign ads or comparative ads. In that case, a game may fill an ad spot with such ads when the player satisfaction value is has reached a local minimum. In an implementation, supplemental content inserted at such low points in the satisfaction value trend line, local minimums or trending down portions of the satisfaction value trend, may focus on themes, products or services that involve taking a break from the game or taking a break more generally, such as ordering or consuming food, taking a vacation, escapist content, recommendations for media content that features vacations or leaving or taking a break, or products associated with comfort or comforting, such as food (sometimes referred to as comfort supplemental content).

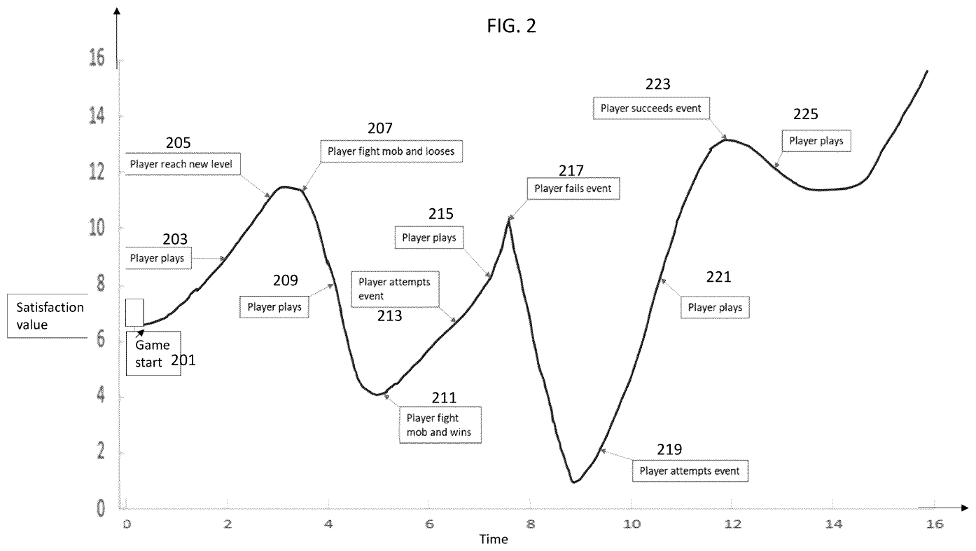

FIG. 2 illustrates computing a satisfaction value trend according to an embodiment in which a video game player's satisfaction value is game context dependent. According to an aspect of this embodiment, the satisfaction value is determined in part by measuring a positive gameplay trend or a negative gameplay trend to estimate player mood, and not based just on individual favorable or unfavorable game events. In an implementation, such a satisfaction value may be computed by scoring every game event or occurrence in real time and adding that score to the previously obtained satisfaction value to keep a running tally of the satisfaction value.

In an implementation, for example, when a player is fighting a mini boss and is in a very tense situation that may lead to elimination of the player from that segment of the gameplay, the game may score the current gameplay event as unfavorable. The satisfaction value may decrease over time in this stretch of the game. As a result, the satisfaction value change may be shown in FIG. 2 as down-trending. Even if one or more subsequent in-game events are determined to be favorable, the satisfaction value may still trend downward. The satisfaction value may be considered upward-trending if the satisfaction value has been increasing considerably for at least a threshold period of time. By way of example, such a threshold period of time may be 2-4 minutes, or 1-9 minutes, however the threshold period may be game-dependent.

In an implementation, when the player has just reached a new level, just discovered a new secret place or a new portion of the game map, just been awarded a new in-game item or other indication in-game achievement, or the like, this results in a local maximum user satisfaction value. Following such a local maximum, a subsequent in-game event may be scored with a lower satisfaction value until another game event is assessed by the game as sufficiently positive to invert the trend. In an implementation, such a subsequent in-game event may cause little increase in the satisfaction value, even if it is positive, which may cause only little change in the satisfaction value. Or, the local maximum may be followed by a high plateau for a period of time, which is then followed by a downward swing or an upward swing.

FIG. 2 shows that after game start at 201, Time 0, game play at 203, around Time 2, is going well. The satisfaction value trend at Time 2 may thus be computed to be high or increasing. A local maximum satisfaction value is obtained at 205, Time 3, when the player reaches a new level, for instance. For example, this may be a personal best (e.g., a new level this player has never reached before, or has not reached within a threshold period of time, for example, for 3-90 days), or this may be a new level attained by the player for this game playing session. The plateau at the local maximum may last for a while, for example, 4-120 seconds as memory of the positive achievement or outcome is fresh in the player's mind At 207, around Time 3.5, the player fights a mob (e.g., a computer-controlled non-player character) or another player-controlled character and loses, which is deemed to be an unfavorable game event. The loss at Time 3.5 may signal that the user's satisfaction value trend had just passed a local maximum. As shown at 209, Time 4, play may continue but the satisfaction value may continue to trend down, such as when the user repeatedly attempts, and fails, to defeat the mini boss. At 211, Time 5, a local minimum satisfaction value is obtained—the player fights the mob and wins, which is scored as a favorable game event. As the player continues to perform well, the satisfaction value increases at a faster rate or pace. At 215, the player satisfaction value is trending up as the player continues to play. At 217, player fails at a relatively significant task or event, or a turn of events generated by the game stymies the player. At 219, the player attempts one or more tasks and player continues playing and, as represented at 221, the satisfaction value is trending up as player meets with some success.

At 223, Time 12, player succeeds at an event, at which point a local maximum in the satisfaction value is obtained. This local maximum at Time 12 may be higher than the previous local maximum at Time 3, if for instance, the player has succeeded in a major event. Or, the local maximum at Time 12 may be higher than the previous local maximum because of a compounding of several in-game events. Play continues at 225, where satisfaction declines, for example, due to repetitive tasks, frustrating events or play gets bogged down.

The game may adjust the magnitude of the satisfaction value in response to the same event if the event is more significant for the particular game for this player. For example, if unfavorable event x may ordinarily be computed as a decrease in satisfaction value of −4, the game may decrease the satisfaction value further for event x if the occurrence of event x at this point in the game hinders the player's progress in the game. By way of example, losing to a boss prevents opening a new section of the game world may result in a satisfaction value of −2, whereas losing against a boss at other occasions ordinarily may result in a satisfaction value of −4.

In an embodiment, the local maximum at Time 12 may be higher than the previous local maximum at Time 3 because this is the first time (e.g., ever, or for this game session, or for the first time in the past month or past 3 months, or the like) this event occurred when this player was playing. For example, the event at Time 12 may be equally or roughly comparably rated in difficulty to the event at Time 3, but the event at Time 12 may be the first time the event occurred when this player was playing, resulting in a greater increase in the satisfaction value. Or, the event at Time 12 may be equally or roughly comparably rated in difficulty to the event at Time 3, but the player may have struggled or toiled for longer in causing event at Time 12, or the player may have solved problems or undertaken tasks or exhibited skills that were new for the player to bring about the event at Time 12, or the player may have brought about the event at Time 12 in record time (e.g., faster than the player has done before), resulting in a greater increase in the satisfaction value.

Attaining an outcome a first time or performing well on a new skill may be more exciting than on subsequent occasions. Accordingly, the first time (e.g., ever for this player, or in this game session for this player, or in this game session for any player in a multiplayer game, or for the first time in a long time, for example, in 10-90 days for this player or for this group of players in a multiplayer game) achievements may be more rewarding than later repeat achievements. Further, the game may increase the satisfaction value more when a player has been soldiering on and struggling and then attains a good outcome (e.g., beats a villain), than when the player attained the same good outcome (e.g., beats the same villain) with less effort or a less sustained effort. Some multiplayer games have group-play content that can be repeated ad infinitum and the game may detect that a player is replaying such content (e.g., taking penalty shots in a video soccer game). In such a case, the game may lower the player satisfaction value if it detects that the player is performing similarly to a previous time. If the content continues to be replayed, the game may even reduce the amount by which the player or user satisfaction value increases (or decreases). At a later time, if the player repeats that same challenge and the game detects a similar gameplay of the player (and/or other players in the same group play), a lower satisfaction value of “trending up medium”may be computed.

A grinding phase (or “resource farming” phase) in videogames are gameplays that consists in repeating certain tasks to obtain certain resources to work towards a certain reward.

For example, in a game to craft a new weapon a player has to build a blade and hilt. To craft the blade, the player needs to mine 100 metal pieces, and to craft the hilt the player needs to gather 100 animal hides; to gather one hide, one has to kill two wolves. The process of mining the metal and hunting the wolves is called grinding. Grinding phases are usually not considered the most thrilling part of a game. In an implementation, the game may lower the local minimum for repetitive grinding phases, or repetitive tasks in such phases. Further, the satisfaction value may be reduced less for a grinding phase earlier in the game than later in the game, because the player may enjoy the novel tasks more initially than during subsequent times or instances that the task has to be performed.

In an implementation, obtaining of the game reward (e.g., obtaining the new weapon) after the grinding phase may cause the game to significantly increase the player satisfaction value to a new local maximum. For example, the boost in player satisfaction value that the game scores in response to obtaining the reward after a grinding phase may be proportional to the amount of time a player has spent in the grinding phase (e.g., the longer the player took to grind through the tasks to obtain the new weapon, the greater the satisfaction value). Further, the satisfaction value after obtaining the game reward may be discounted later in the game compared to earlier in the game or compared to the first time ever this player attains the reward (e.g., obtains the new weapon).

In an implementation, if the supplemental content is an advertisement, values associated with advertised products may align with the magnitude of relative maximums or minimums: supplemental content featuring a higher value (e.g., higher monetary cost or value) may be positioned at higher local maximums than supplemental content featuring lower value items. For example, an ad for a game controller may be provided after defeating the mini-boss, and an ad for a new television could be provided after defeating the main boss.

In an implementation, when a game is stopped or paused, the game may store the satisfaction value of the player, such that when the game is resumed, the satisfaction value may be retrieved for continued game play to time and to select further supplemental content. In another implementation, the stopping or pausing the game may start a timer, and if the game is resumed within a threshold amount of time, for example, 0-30 minutes, or 0-180 minutes, then the satisfaction value of the player would be resumed. In an implementation, the satisfaction value may decay between play times. For example, after the game is paused or stopped, the satisfaction value may decay to some lower level or value. By way of illustration, the satisfaction value may gradually decay as a function of time-which may approximate the user's mood or attitude toward the game or the user's performance in the game. The satisfaction value may eventually reach zero over time. In an implementation, it would never reach zero if the same game was restarted after pause or restart.

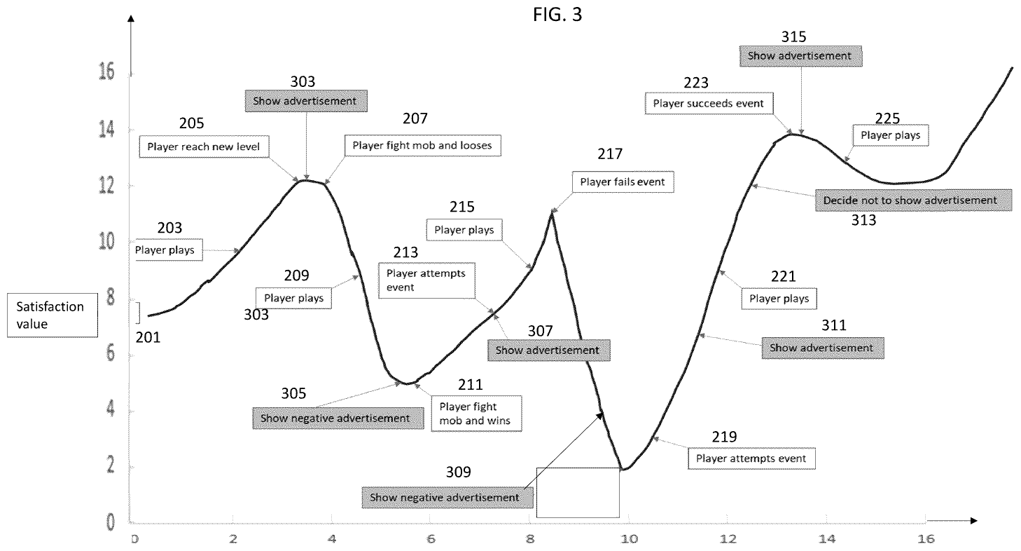

FIG. 3 is an example of supplemental content items that may be selected for insertion at various points in the course of the game based on local maximums or minimums or based on a sustained trend. A game, for example, may decide to insert the supplemental content only when the satisfaction value is at or around a local maximum, thus associating a positive event in-game with the supplemental content. When the supplement content item contains an advertisement, positive association is important and is sought after by marketers to improve the efficiency or effectiveness of their ads. A game may also include the player satisfaction value as a parameter when auctioning an ad spot. For example, the game may get a higher cost per thousand (CPM—the price an advertiser pays per one thousand advertisement impressions) for advertisements that are shown when the player satisfaction value is at a local maximum than when the satisfaction value is increasing, and may an even lower CPM when the player satisfaction value is decreasing or has reached a local minimum.

As shown in FIG. 3, supplemental content may be shown at 205, Time 3, the first local maximum satisfaction value level. In an embodiment, this may be a prime location for supplemental content, inserted at 303, because it may be the first display of positive supplemental content in the game. Thus, user attention may be primed. At 305, Time 5, a negative-themed piece of supplemental content may be displayed. At 307, Time 7 is a time of satisfaction value upswing and a positive themed piece of supplemental content may be called for. Time 10 marks a local minimum in the satisfaction value, which may be ideal for a negative (and/or consolation etc.) themed supplemental content. Time 12 and Time 13 correspond to a satisfaction value upswing and positive themed pieces of supplemental content may be called for, as shown at 311 and 313. The high local maximum satisfaction value level at 315, Time 14, may call for further positive supplemental content.

Supplemental content may be displayed at different times to users interacting with the interactive content via different devices. For example, in a multiplayer game, a first user using a first device may be performing well and thus may be shown supplemental content at a local maximum. An opposing player using a second device may be losing to the first player and thus may be shown no supplemental content at this point in the game.

In an implementation, the game may use a timer after an event before inserting supplemental content. For example, after a negative game event at Time 10, an upward trend starts but the next supplemental content may be delayed until Time 11. Or, after a victory, the player's attention may be focused on an automated victory sequence before actual play resumes, and the supplemental content may be paused for a time. The player may be celebrating the positive event and not be ready for supplemental content until normalcy returns. Such a wait time after an important game event may be 3-10 seconds or 1-30 second.

Supplemental content may be associated with metadata marking it as positive or negative. In an embodiment, a trained machine learning model (e.g., a neural network, such as a convolutional neural network, native Bayes model, logistic regression, convolutional etc.) may be used to classify, according to “positive” or “negative” content, messaging or themes, the various pieces of supplemental content to be shown for an interactive media session. For example, a set of advertisements may be retrieved for insertion into a game, and the trained machine learning model may be used to classify the advertisements so that they may be inserted at appropriate moments in the game. In an implementation, as discussed, advertisements involving themes of comfort, food, vacation, or taking a break may be classified for insertion at lower satisfaction value points and/or at local minima or downward trends, even if they entail upbeat, happy or otherwise positive messaging or themes.

In an embodiment, the trained machine learning model may also be used to quantify or rank the “positivity,” “negativity,” and/or “comfort content” of the supplemental content to be shown for an interactive media session. For example, supplemental content may be classified into very upbeat and upbeat, negative and very negative clusters. By way of further example, supplemental content may be classified into very comfort-oriented and comfort-oriented comfort (e.g., comfort-oriented, as discussed, may include themes of comfort, food, vacation, or taking a break may be classified for insertion at lower satisfaction value points and/or at local minima or downward trends, even if they entail upbeat, happy or otherwise positive messaging or themes). Based on such classification, very positive supplemental content may be shown at peak satisfaction times, for example, when a player wins a game or match, beating a major villain or adversary after trying and failing to do so numerous times, advances to a major new game tier or level after trying and failing to do so numerous times, or the like.

In an embodiment, in order to use engagement metrics across multiple games so that supplemental content placement opportunities may be compared across different games or other interactive media, the game may normalize its player satisfaction value, for example, per the following list: local maximum, local minimum, trending up, trending down. To distinguish between high lows and low lows for example, the game may also qualify the satisfaction value as low, medium and high. Illustratively, a high local maximum satisfaction value may be computed for a player winning or attaining a very difficult event after having failed multiple times after the event and then a trending up high satisfaction value score during the event. Conversely, a local maximum low satisfaction value score may be computed for a player who just played and attained level 2 by beating a couple of monsters and then the satisfaction value score may trend up low.

In another implementation, the game may decide not to show supplemental content when a player satisfaction value is trending up high so as to maximize the effectiveness of showing supplemental content when a player satisfaction value reaches a new local maximum.

According to an embodiment, the game may measure the gameplay time when the normalized player satisfaction value is stable and decide to show supplemental content when that time exceeds a game-defined stability threshold. The stability threshold, for example, may be set for some time period of 2-4 minutes, or 1-9 minutes, as relatively stable play without dramatic events or changes.

The game may predict gameplay time to a local maximum or a local minimum of the satisfaction value, and factor in this prediction in the timing of the presentation of supplemental content. This is based on the notion that showing supplemental content a single time at a local maximum may be more efficient (e.g., makes more of an impact on the viewer) than the combination of showing supplemental content during a positive uptrend and a second one when the maximum is reached since they are shown close to each other. Such predicting of a play outcome may consist in aggregating player output over time and comparing it to an expected total output to reach that outcome. For example, in a boss fight, the boss has a certain level of health x and the player as an average damage output d per second, the predicted time to beat that boss is x/d seconds. The way outcomes and times for such outcomes are computed is highly dependent on the type of game and its mechanics. User history of game interaction in such situations may also be accessed to determine a likelihood and used to predict success in the fight with the boss or to estimate timing of success in the fight with the boss.

For example, if the player satisfaction value has been trending up for 3.5 minutes the game may decide that a stability threshold has been reached and trigger a display of supplemental content. For example, if the player satisfaction value has been trending up for 3.5 minutes and the stability threshold for showing supplemental content is four minutes, then the game may display the supplemental content. On the other hand, if the game predicts that the player satisfaction value will reach a new local maximum within one minute, it may delay the insertion of supplemental content until the new local maximum is reached.

In an embodiment, game content or the presentation mode of supplemental content, or both, may be adjusted based (at least) on the satisfaction value. In an example, the game may detect that the player satisfaction value is trending up and, accordingly, may predict that it is likely to reach a local maximum within a threshold timeframe. In an implementation, if the supplemental content comprises one or more advertisements, this threshold time frame may have to be longer than an ad period threshold—the minimum time period that a player is not subjected to an ad so as to avoid over taxing the attention of the player and minimizing the effect of the supplemental content. Based on this prediction, a first version of an ad may be presented using a first modality. Later, when the player satisfaction value reaches a local maximum that was earlier predicted, the game may show a second version of the ad using a second modality. Illustratively, if a player is playing a video game of tennis and winning, the game may show a banner ad on the side of the tennis court. Once the player wins the tennis game, during a victory cutscene a video version of the ad may be displayed on the main display above the tennis court where the tennis scores are usually presented. Or, continuing with this example, the first modality supplemental content—the banner ad—may not be presented, and only the second modality supplemental content may be presented during the victory cutscene.

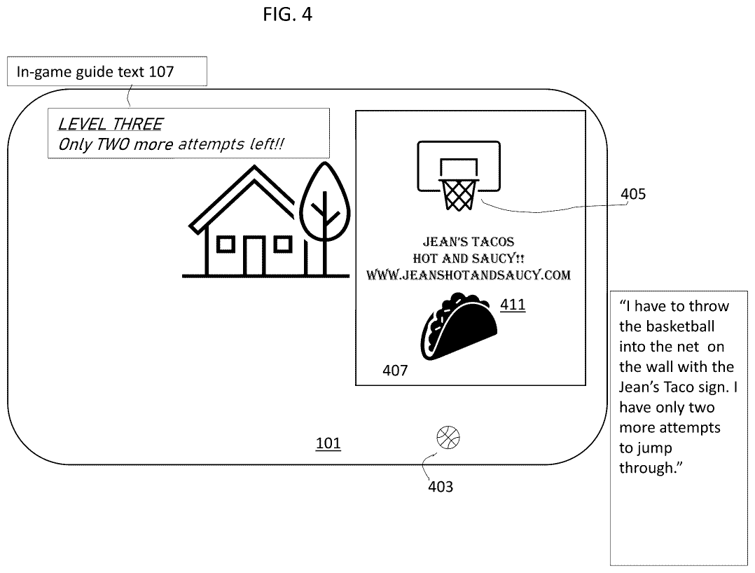

In an embodiment, a player's supplemental content engagement metric (SCEM) may be computed based on parameters such as the player's intensity of focus on an area of user interaction where the supplemental content is, or is to be displayed. Thus, the engagement metric of a user is a value that indicates or predicts the degree of focus or attention of a user on the particular area, such as portion of a game at or near the area of player interaction provided by a graphical user interface. As shown in FIG. 4A, the user has an in-game task that entails aiming a basketball 403 into a basketball net 405 on a wall 407 with an ad 411 for a restaurant. The focus of the user may be predicted to be directed immediately or approximately adjacent, in, on, through, around, near, in front of, or behind the display of the supplemental content; in this case, it may be directed just above the supplemental content.

A player's SCEM may be computed based on how much focus or attention of the player is required for completion of the in-game task and how close or salient the supplemental content is in relation to the in-game task. For example, a high player engagement metric level may be computed based on a high level of player focus. In an embodiment, the SCEM value may be computed on a scale of 0-1, with 1 being the highest. However, the player's SCEM value may be weighted according to how prominent the display of the supplemental content in relation to other game graphics and how close/remote the supplemental content is from the area of focus. For example, if all of a player's attention and focus is expected or predicted to be, or is measured to be based on eye movement tracking, on an area where the supplemental content is being displayed, a SCEM value of 1 may be initially computed.

The player's area of focus may be used to decide the timing and location of the display of supplemental content. For example, in a first-person shooter situation, the game may have the opportunity to insert supplemental content on a wall a player is running next to. If the game detects that motion blur created by the fact that the player is running at high speed or is aiming around, it may decide to display a low complexity modality of an ad. On the other hand, if it detects that the player is moving slowly and that the display quality of the ad on the wall will be at maximum or exceed a threshold, the game may decide to display a higher complexity modality of the supplemental content. Illustratively, the game may display a big red and yellow logo of a fast food chain on the wall if the player is moving fast, whereas it may display a more detailed version of an ad for the fast food chain including, not only the logo, but also a picture of a hamburger and a slogan.

In another example, the game may display different modalities of an ad based on the SCEM of a player detected by computing the player's field of view in game. Illustratively, a game may detect that a player is facing a wall 90 in-game meters away from their location and, in response to this, may display a first modality of an ad consisting of a high contrast low resolution image (the fast food logo in the previous example). However, upon detecting that the player has now zoomed in on a location close to where the first modality of the ad is displayed (such as, for example, in a first-person shooter using a sniper rifle scope), the game may replace the first modality of the ad by a second modality showing more information and with a better resolution (such as the higher complexity version of the fast food ad in the previous example).

In an implementation, a game may measure or predict the time remaining until a supplemental content display area (e.g., an area of the screen in which an ad will be displayed) will come into focus, or is predicted to appear given the current progress of the player in the game. According to the player's SCEM predicted for that opportune time, the supplemental content may be selected or prepared for that time.

In an embodiment, SCEM may be used to report a quality of the impression of supplemental content. For example, when an ad is displayed very near or on area where the player is engaged in shooting a basketball, or the player's avatar is standing on a platform on where the ad is displayed, then the quality of the impression of the supplemental content may be reported as high. On the other hand, if the supplemental content is a banner ad that is displayed not adjacent the predicted area of focus of the player, the impression quality may be reported as low. The cost of the supplemental content for the advertiser may thus be determined according to the SCEM.

In an embodiment, the game may register impressions based on the SCEM as determined based on cumulative focus and attention measurement. For example, the game may determine the number of times the player pans the scene. If the game detects that the player runs straight (e.g., in first-person shooter games, such as Fortnite) and the ad is in plain view and not obscured, the game may computer that SCEM is high, and count that totality as a full impression. Similarly if the player is looking at the ad or is facing the ad for some amount of time, a high SCEM may be computed. Conversely, if the game detects that the player is running left and right and the ad surface comes into view for an amount of time below a pre-set impression duration threshold, for example, 0.5-1 seconds, or 0.2-3 second, or is displayed with a stability or motion blur quality below a pre-set impression stability or quality threshold, a low SCEM value may be computed, and according to the SCEM, the full impression of the associated ad may be weighted lower.

In some other examples, the game may be a multiplayer game in which players either cooperate to achieve a common goal or compete against each other. Using a game engagement metric (GEM), the game may determine whether it is an opportune time to show supplemental content to a first player and/or a second player.

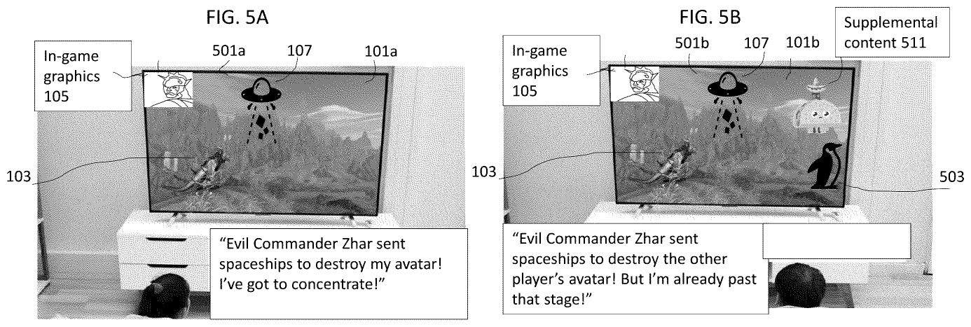

As example of this is shown in FIGS. 5A and 5B. An avatar 103 of a first player of a multiplayer game displayed as part of a first graphical user interface 101a on a first device 501a is in the midst of a valiant fight, as show in FIG. 5A. The GEM of the first player is determined to be high-the player is engrossed in the game because of the intense game action. In an embodiment, the GEM value may be computed on a scale of 0-1, with 1 being the highest. For example, if all of a player's attention and focus is expected or predicted to be, or is measured to be based on eye movement tracking, on the game, then a GEM value of 1, or near 1, may be computed. Other ways of tracking user attention, such as metadata from the game segment, measure of interaction such as speed of pressing buttons on a controller and the like, are also contemplated. Based on the GEM value, it may be determined that this is not an opportune time to provide supplemental content. For example, the role of the player may be driver in the game and the focus of the driver is predicted to be on the road. Accordingly, the first graphical user interface 101a on the first device 501a displays no supplemental content at this time.

FIG. 5B shows avatar 503 of a second player of a multiplayer game displayed as part of a second graphical user interface 101b on a second device 501b. This avatar is not in a fight and at the moment is walking to a next challenge. Thus, this player's attention and focus is expected or predicted to be, or is measured to be based on eye movement tracking to be, less intensely focused on the game, or any singly part of the graphical user interface 101b. Thus, this player's attention is more freely available and is more likely to engage with supplemental content.

Accordingly, a GEM value of 0, or near 0, may be computed. Since the GEM of the second player is determined to be low, the second graphical user interface 101b on the second device 501b displays supplemental content 511. On the other hand, if the game determines, for example, based on eye movement tracking, that this player is not focused on the graphical user interface at all (e.g., is focused on something other than the display 501b, has removed the XR head mounted device, or the like), then no GEM score may be computed, and the game may decide not to display supplemental content for the user.

The game may choose to select a first modality for displaying the supplemental content to the first player on the first graphical user interface 101a of the first device 501a and a second modality for a second player on the second graphical user interface 101b on the second device 501b based on the attention and focus level of the first player and the second player. In an implementation, the mode of displaying the supplemental content may be based, at least in part, on the role or task of a player in the game, or at this point in the game. Thus may sometimes be referred to as the interactive content role of the user. Illustratively, the first player may be driving a vehicle avoiding obstacles while the second player may be riding in a passenger location, sometimes performing actions such as shooting incoming enemies. In this example, the first player's interactive content role is driver while the second player's interactive content role is shooter. In that phase of a game, the level of attention of the first player is higher than that of the second player. The GEM of the first player may thus be determined to be high, and the GEM of the second player may be determined to be low. Continuing with this example, the game may generate a billboard on the driver side showing an ad with a low attention modality such as the fast food logo of a previous example, while showing a more complex modality of the ad of the fast food chain on a billboard that it displays on the passenger side. In an embodiment, if the same monitor or display is used by both players, then the billboard on the driver side showing the ad with a low attention modality and the ad with the more complex modality on the billboard displayed on the passenger side may be provided as part of the same graphical user interface of the same display. Conversely, if the player who is the driver only has to drive a straight line but the passenger has to shoot a lot of adversaries, the game may invert the modalities. In this example, the game may calculate the GEM by counting the number of actions on the controls (such as a keyboard, a mouse, or a controller) a player is expected or predicted to perform, or is performing, over a period of time (e.g., user commands per second).

As discussed, the GEM value determined for the respective players may be used to determine whether to display supplemental content for one, both or none of them, and may determine the modality of the display of the supplemental content. Based on the determined time and the determined modalities in the two player scenario, if the player in the shooter role is expected to aim at or near a billboard on which the supplemental content is displayed, then the SCEM value of the supplemental content for this player may be computed to be high. That is, this player's attention and focus is expected, or is predicted based on user history determined from a user profile, or is determined based on where the player's mouse pointer or joystick is aiming, to be on or near the supplemental content. The user profile information may indicate that this and/or other game users interacted with the game, for example, based on the commands they entered or other user actions detected. Conversely, player in the driver role is not expected to focus on the billboard, and thus the SCEM value of the supplemental content displayed on the billboard for the player in the driver role may be computed to be low. In an XR use case, eye movement tracking may entail the use of a camera in a head mounted display, and may entail head movement tracking.

Also, contemplated is an in-game real life interaction interface. A videogame may detect that a player is ready to interact with a brand in real-life. For example, in a multi-player setting, the game may monitor in-game voice chat and run speech-to-text and NLP analysis to detect discussions about a brand. The game may also do the same with in-game text-chat. For example, natural language processing or other linguistic analysis circuitry may apply linguistic, sentiment, and grammar rules to tokenize words from a text string of a comment; identify part-of-speech (i.e., noun, verb, pronoun, preposition, adverb, conjunction, participle, article); perform named entity recognition; and identify phrases, sentences, proper nouns, or other linguistic features of the text string. In some embodiments, statistical natural language processing techniques may be employed. The extracted keywords may be compared to keywords stored in a database to perform semantic and/or sentiment analysis in order to determine whether a particular comment is indicative of user interest in an item or in a vendor. In another example, the game may allow the player to interact freely using voice or text input with Non-Playable Characters (NPCs-characters generated by the game and not controlled by the player(s)) and detect an intent to interact with a brand by monitoring such interactions. Based on that interaction, the game may generate an in-game store for that brand where the player may be presented with various products they can buy and have delivered without exiting the game world.

Illustratively, the player may have indicated that the player is in the mood for pizza, or the game may infer this mood through other signals, such as a user preference profile that indicates a time of day the player historically takes a break, eats lunch, gets hungry, or the like.

The game may auction up that information or may otherwise offer the opportunity to present interactive ads to various pizza delivery services such as national pizza delivery service A, or local/regional pizza place B. Upon obtaining a bid from one of the services, the game would then generate an interactable store in which the player may purchase a pizza and have it delivered without leaving the game. The game may generate a side-quest to guide the player to the store.

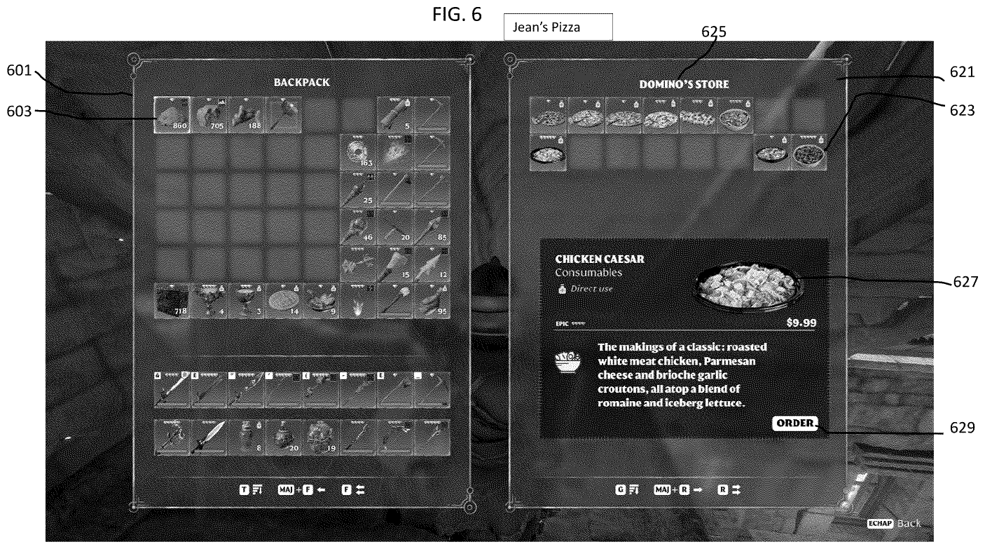

As part of the auction process, the game may obtain API addresses from each ecommerce service it queried (e.g., the pizza stores) to streamline the integration of the real-world interface ads into the game world (e.g., by displaying real-world ads or a real-world menu, in a style similar or reminiscent of the game interface). Shown in FIG. 6 is an in-game interface showing a “backpack” of weapons owned by a player, with a number for each weapon showing the “stack”—the number of each weapons available. On the right side in FIG. 6 is an in-game interface showing real-world items provided as a menu for a real-world pizza food, in which menu items are shown in a style similar to the weapons and other items in the player's backpack.

In another example, the game may auction the location of a pop-up virtual store in the game world in relation to a current position of the player or player's avatar in the game world, or in relation to the player, or the player's avatar's, predicted most likely destination based on the game progress. For example, if the player is located in area A of the game but is on a quest that may lead the player to area B and may, in a less likely scenario, lead the player to area C, the game may auction off area A at a high price, area B at a medium price and area C at a lower price. The game may then generate several mutually exclusive side-quests to guide the player towards these interfaces. It may also reward the player differently in-game based on the result of the area auction (e.g., reward the player in the game if the player chooses the quest that leads to area A).

In another example, the game may have obtained the information that a player prefers a certain brand when shopping online or in-game. For example, it may be determined based on user profile information that when the player wants to order a pizza, the player visits pizza brand A's in-game virtual interface/store or otherwise orders from brand A pizza. The user profile information may indicate that this and/or other game users ordered food from this or other vendors, as well as other user habits. The game may auction the generation of a pop-up virtual interface/store to another brand (say, brand B pizza) in an advantageous location of the game area. This may allow brand B to nudge the player to the other brand. The game may also generate a series of side-quests, each side-quest leading to a visit to the virtual stores. A higher in-game reward may be granted to the player for choosing the side-ques that leads to the brand B in-game store.

In an embodiment, to avoid breaking in-game immersion, the game may allow payment for real-world goods in a virtual pop-up store using in-game currency that, as part of a game service, is converted from fiat currency. For example, the game may act as an intermediary between the ecommerce store and the player for the transaction by allowing the player to purchase the real-world pizza using game currency/points. The player may purchase game currency/points using real-world dollars. The game may generate a transaction directly with the ecommerce storefront and re-bill the player using a credit card on file.

The game may generate each of the virtual pop-up stores in a style that matches the game environment and with interaction that matches in-game mechanics. For example, the game may replicate its inventory management page 601 to facilitate buying product in the virtual pop-up store 621 as illustrated in FIG. 6. The creation of the game assets 603 to represent the items 623 to be bought in real-life may be automated with known techniques, such as style transfer using generative guided image models (e.g., generative AI, for example, a trained machine learning model, that creates an image in response to a prompt). A brand 625 may provide pictures 627 of its products replicating the style or look and feel of the game items, for example, the menu items of brand A pizza, but in the style of the game. Using generative guided models, such automated population of an in-game interface may be rapid. An ordering function 629 for the items and a payment page could also be so integrated.

In another example, the game may reward the player with in-game virtual advantages for some actions. In the example shown in FIG. 6, upon ordering the salad, the salad item may be inserted into the in-game inventory and may be available for in-game consumption upon delivery. Illustratively, the “Chicken Caesar” that the player ordered may grant the same in-game advantages as any other consumables collected in-game. For example, if collecting an in-game salad grants protection against ghosts for 10 minutes upon consumption, consuming the Caesar Chicken in-game may grant the same protection. Games may encourage transaction by granting unique or better advantages in-game for items bought in real-life with an equivalent in-game.

In an implementation, one or more such virtual pop-up store, or a menu featuring items from more than one store or vendor, may be displayed in response to user interaction of supplemental content. For example, in response to a satisfaction value, supplemental content may be displayed. The supplemental content may include a URL or an actionable option that, when selected by the user, causes display of the virtual pop-up store, or a menu. Or, the supplemental content that is displayed based on the satisfaction value may include the virtual pop-up store, or a menu. By way of example, if the virtual pop-up store or menu is for ordering food item, such supplemental content may be displayed at a local minimum of the satisfaction value. In an embodiment, the interactive medium may be automatically paused when one or more items on the virtual pop-up store or menu is selected.

In an embodiment, a virtual reality game may generate a walkable scenario that may include a trip to the door to get the goods once they are delivered. The VR game may generate interactable elements in-game such as a door to be opened or merchandises to be picked up and command the VR headset to render them as the player moves from their original in-game position in the real world to the location where they need to pick up their merchandise. The game may be able to create a virtual environment that matches the geometry of the player's real-life environment based, for example, on a 3D scan of a player's dwelling, obtained either during a setup phase for the VR headset or from a gamified training session the first time a player uses the in-game real-life delivery feature. In a non-VR environment, the game may generate notifications using the same mechanics as for other events in the game to inform the player that their real-life item has been delivered. The game may, for example, disable the digital version of the bought item in the player's inventory and then activate the item for use in the game when the real-world item has been delivered. For example, a player may inform the game that the player has taken delivery or received the real-life product (for example, by scanning a QR code on the delivered product packaging using a game companion application) to activate the in-game item. According to another example, the game may generate a quest, or some other in-game activity, to inform the player that the ordered product has been delivered.

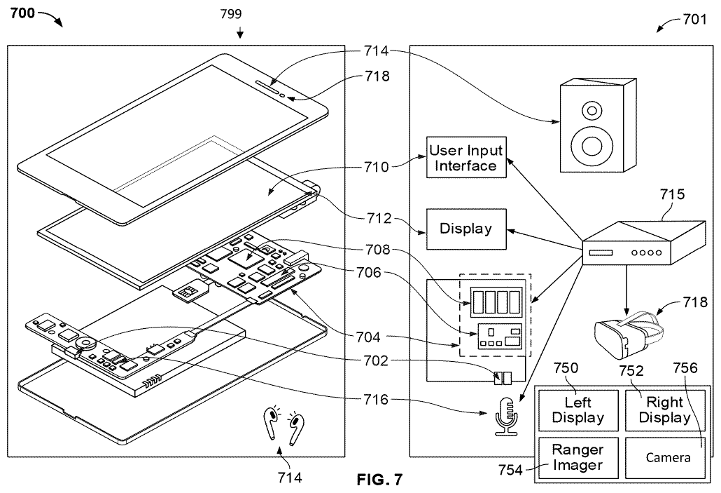

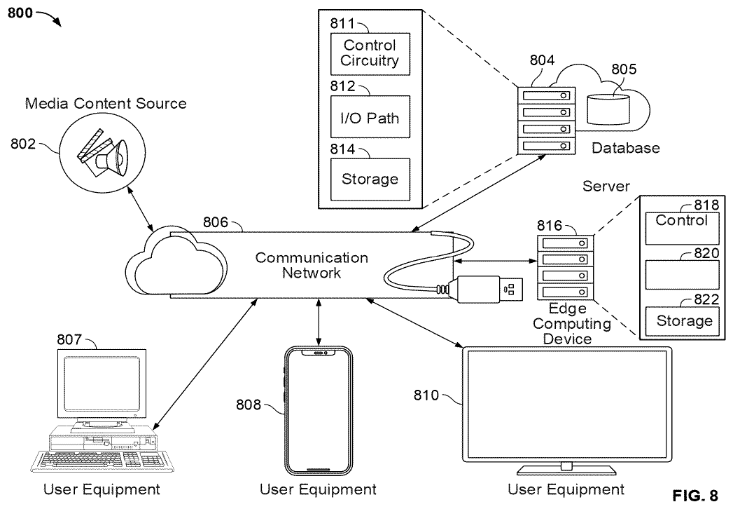

FIGS. 7-8 describe illustrative devices, systems, servers, and related hardware for providing supplemental content relevant, in accordance with some embodiments of the present disclosure. FIG. 7 shows generalized embodiments of illustrative user equipment devices 700 and 701, which may correspond to user equipment device 104, 204 of FIGS. 1 and 3, respectively, and/or a second screen device. For example, user equipment device 700 may be provided as, or connected to, an extended reality (XR device). In another example, user equipment device 701 may be a user television equipment system. User television equipment device 701 may include set-top box 716. Set-top box 716 may be communicatively connected to microphone 718, speaker 714, and display 712. In some embodiments, microphone 718 may receive voice commands for the media application. In some embodiments, display 712 may be a television display or a computer display. In some embodiments, set-top box 716 may be communicatively connected to user input interface 710. In some embodiments, user input interface 710 may be a remote control device. Set-top box 716 may include one or more circuit boards. In some embodiments, the circuit boards may include processing circuitry, control circuitry, and storage (e.g., RAM, ROM, hard disk, removable disk, etc.). In some embodiments, the circuit boards may include an input/output path. More specific implementations of user equipment devices are discussed below in connection with FIG. 7. Each one of user equipment device 700 and user equipment device 701 may receive content and data via input/output (I/O) path 702. I/O path 702 may provide content (e.g., broadcast programming, on-demand programming, Internet content, content available over a local area network (LAN) or wide area network (WAN), and/or other content) and data to control circuitry 704, which includes processing circuitry 706 and storage 708. Control circuitry 704 may be used to send and receive commands, requests, and other suitable data using I/O path 702, which may comprise I/O circuitry. I/O path 702 may connect control circuitry 704 (and specifically processing circuitry 706) to one or more communications paths (described below). I/O functions may be provided by one or more of these communications paths, but are shown as a single path in FIG. 7 to avoid overcomplicating the drawing.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i7 processor and an Intel Core i9 processor). In some embodiments, control circuitry 704 executes instructions for the media application stored in memory (e.g., storage 708). Specifically, control circuitry 704 may be instructed by the media application to perform the functions discussed above and below. In some implementations, any action performed by control circuitry 704 may be based on instructions received from the media application.

In client/server-based embodiments, control circuitry 704 may include communications circuitry suitable for communicating with a media application server or other networks or servers. The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media application data described above. Nonvolatile memory may also be used (e.g., to launch a boot-up routine and other instructions). Cloud-based storage, described in relation to FIG. 8, may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of user equipment 700. Control circuitry 704 may also include digital-to-analog converter circuitry and analog-to-digital converter circuitry for converting between digital and analog signals. The tuning and encoding circuitry may be used by user equipment device 700, 701 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment device 700, the tuning and encoding circuitry (including multiple tuners) may be associated with storage 708.

Control circuitry 704 may receive instruction from a user by way of user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of each one of user equipment device 700 and user equipment device 701. For example, display 712 may be a touchscreen or touch-sensitive display. In such circumstances, user input interface 710 may be integrated with or combined with display 712. Display 712 may be one or more of a monitor, a television, a display for a mobile device, or any other type of display. A video card or graphics card may generate the output to display 712. The video card may be any processing circuitry described above in relation to control circuitry 704. The video card may be integrated with the control circuitry 704. Speakers 714 may be provided as integrated with other elements of each one of user equipment device 700 and user equipment system 701 or may be stand-alone units. The audio component of videos and other content displayed on display 712 may be played through the speakers 714. In some embodiments, the audio may be distributed to a receiver (not shown), which processes and outputs the audio via speakers 714.

The media application may be implemented using any suitable architecture. For example, it may be a stand-alone application wholly-implemented on each one of user equipment device 700 and user equipment device 701. In such an approach, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to provide supplemental content as discussed. Based on the processed instructions, control circuitry 704 may determine what action to perform when input is received from user input interface 710. For example, movement of a cursor on a display up/down may be indicated by the processed instructions when user input interface 710 indicates that an up/down button was selected.

In some embodiments, the media application is a client/server-based application. Data for use by a thick or thin client implemented on each one of user equipment device 700 and user equipment device 701 is retrieved on-demand by issuing requests to a server remote to each one of user equipment device 700 and user equipment device 701. In one example of a client/server-based guidance application, control circuitry 704 runs a web browser that interprets web pages provided by a remote server. For example, the remote server may store the instructions for the application in a storage device. The remote server may process the stored instructions using circuitry (e.g., control circuitry 704) to perform the operations discussed in connection with FIGS. 1-6 and 10.

In some embodiments, the media application may be downloaded and interpreted or otherwise run by an interpreter or virtual machine (run by control circuitry 704). In some embodiments, the media application may be encoded in the ETV Binary Interchange Format (EBIF), received by the control circuitry 704 as part of a suitable feed, and interpreted by a user agent running on control circuitry 704. For example, the media application may be an EBIF application. In some embodiments, the media application may be defined by a series of JAVA-based files that are received and run by a local virtual machine or other suitable middleware executed by control circuitry 704. In some of such embodiments (e.g., those employing MPEG-2 or other digital media encoding schemes), the media application may be, for example, encoded and transmitted in an MPEG-2 object carousel with the MPEG audio and video packets of a program.

FIG. 8 is a diagram of an illustrative system 800 for AR generation, in accordance with some embodiments of this disclosure. User equipment devices 807, 808, 810 (e.g., which may correspond to one or more of computing device 100, 501a, 501b may be coupled to communication network 806. Communication network 806 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 806.

System 800 may comprise interactive media content source 802 (e.g., an online game provider), one or more servers 804, and one or more edge computing devices 816 (e.g., included as part of an edge computing system, such as, for example, managed by mobile operator). In some embodiments, the AR application may be executed at one or more of control circuitry 811 of server 804 (and/or control circuitry of user equipment devices 807, 808, 810 and/or control circuitry 818 of edge computing device 816).

In some embodiments, server 804 may include control circuitry 811 and storage 814 (e.g., RAM, ROM, Hard Disk, Removable Disk, etc.). Storage 814 may store one or more databases. Server 804 may also include an input/output path 812. I/O path 812 may provide AR generation data, device information, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically control circuitry) to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

Edge computing device 816 may comprise control circuitry 818, I/O path 820 and storage 822, which may be implemented in a similar manner as control circuitry 811, I/O path 812 and storage 824, respectively of server 804. Edge computing device 816 may be configured to be in communication with one or more of user equipment devices 807, 808, 810 and video server 804 over communication network 806, and may be configured to perform processing tasks (e.g., AR generation) in connection with ongoing processing of video data. In some embodiments, a plurality of edge computing devices 816 may be strategically located at various geographic locations, and may be mobile edge computing devices configured to provide processing support for mobile devices at various geographical regions.

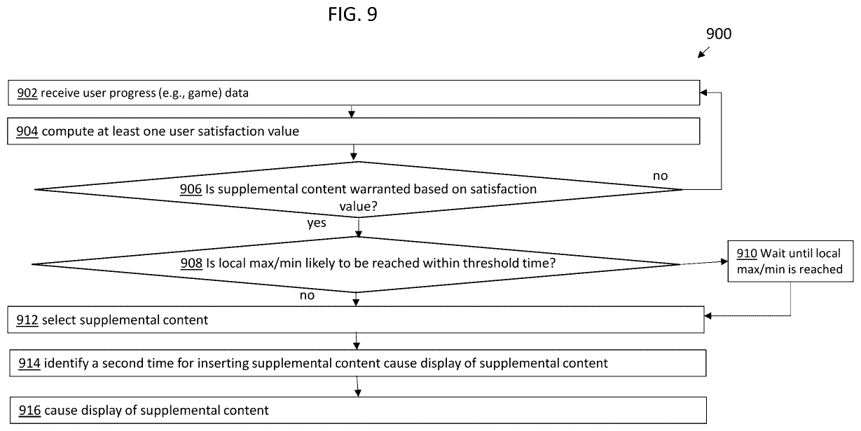

FIG. 9 is a flowchart showing a process 900 for determining a timing of supplemental content placement in interactive content, according to an example of an implementation of the present disclosure. The process 900 may be implemented, in whole or in part, by the systems shown in FIGS. 7 and 8. One or more actions of the process 900 may be incorporated into or combined with one or more actions of any other process or embodiment described herein. The process 900 may be saved to a memory or storage (e.g., the storage of the system shown in FIG. 7) as one or more instructions or routines, which may be executed by any suitable device or system having access to the memory or storage to implement the process 900.

At 902, user progress data may be received based on one or more events in the interactive content. At 904, at least one user satisfaction value is computed based at least on the one or more events in the interactive content. The at least one satisfaction value may comprise a series of satisfaction values computed in response to events in the interactive content.

A trend or other type of pattern of satisfaction values may be determined in the series of values. Based on a cumulative satisfaction value or based on the pattern of satisfaction values, at 906 it is determined whether, based on the satisfaction value, insertion of supplemental content is warranted. As discussed, this determination may be based on several factors. If it is not warranted, then processing returns to 902—additional user progress information with the interactive media is received. On the other hand, if the display of supplemental content is warranted then processing continues to 908.

At 908, the interactive content application may determine that a local maximum of the satisfaction value or a local minimum of the satisfaction value may soon be reached (e.g. is predicted to be reached based on current progress of the game within a threshold period of time). This determination may be based on the rate of change in the satisfaction value—the rate at which the satisfaction value has been decreasing or decreasing, for example, over the most recent period of time in the game, e.g., 10-300 seconds. For example, this may be predicted based on progress of the user in the interactive content or based on knowledge of upcoming events that the interactive content is likely to generate next. For example, a prediction may first be made about a likely outcome of an upcoming or current interactive media event based on such factors as the current progress of the game, including the performance of the player in completing tasks, winning fights or matches against human or machine-based opponents, or the speed of the foregoing, the user history of performance in tasks similar to the upcoming or current interactive media tasks, the odds of users generally meeting the upcoming or current challenge, or the level of difficulty of the upcoming or current challenge, or a combination of two or more of the foregoing. If the local maximum or minimum is predicted to be soon reached, then at 910, display of the supplemental content may be delayed until that the local maximum or minimum is reached.

At 912, if the local maximum or minimum is not determined to be soon reached, then a supplemental content may be selected. The selection of the supplemental content may be determined before any of the preceding steps or before start of process 900.

At 914, a time for causing display of a supplemental content may be identified. The time for causing insertion of the supplemental content may be at the earliest time or may be a time set in the future. This time for causing display of a supplemental content may first be determined before 908, and if at that point it is determined that the local maximum or minimum is within a threshold time, then the display of the supplemental content may be delayed—the time for causing display of a supplemental content may be re-calculated based on the upcoming local maximum or minimum.

At 916, the supplemental content is caused to be displayed by the graphical user interface of the user's device. The supplemental content may be displayed in the interactive content, for example, on a virtual surface in a game. In an implementation, the supplemental content may be displayed by the graphical user interface of at some other part of user's device.

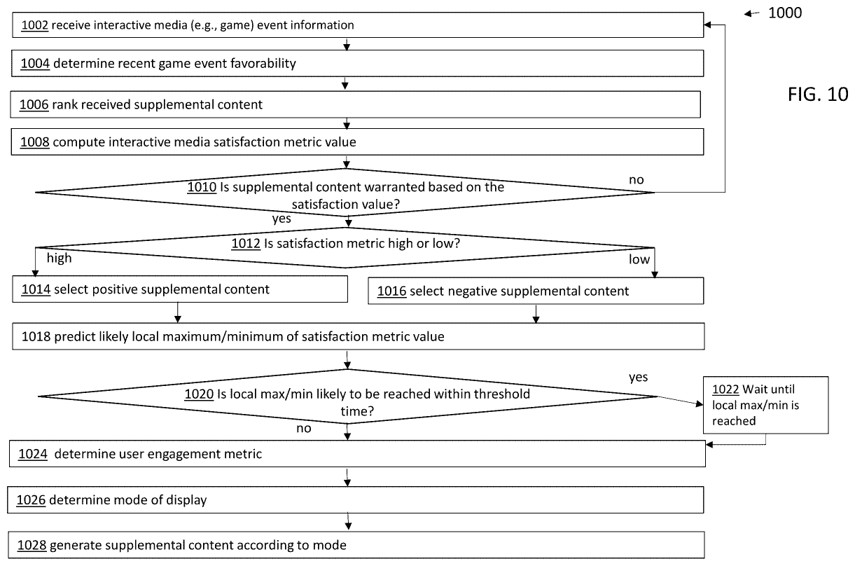

FIG. 10 is a flowchart showing another process 1000 for selecting of supplemental content, according to an example of an implementation of the present disclosure. The process 1000 may be implemented, in whole or in part, by the systems shown in FIGS. 7 and 8. One or more actions of the process 1000 may be incorporated into or combined with one or more actions of any other process or embodiment described herein. The process 800 may be saved to a memory or storage (e.g., the storage of the system shown in FIG. 7) as one or more instructions or routines, which may be executed by any suitable device or system having access to the memory or storage to implement the process 1000.

As shown in FIG. 10, the interactive media application, or a satisfaction value application communicating therewith, at 1002 receives event information about one or more occurrences in the interactive media. For example, a player may have just had a significant win or loss against a villain in a game.

At 1004, the application may determine whether the event is favorable to the user. For example, the game may access a data structure that stores a point value for game events (e.g., favorable events scored 1 to 10, with 10 being the most favorable, unfavorable events ranked −1 to −10, with −10 being the most unfavorable) or ranks game events in relation to each other according to favorability or unfavorability.

At 1006, a set of supplemental content may be ranked or classified according to their positive, negative and/or comfort-themed, food-themed or escapist content. For example, a set of supplemental content appropriate to the interactive media, appropriate the user, or appropriate to this user session of interactive media may be received, and ranked and classified. It will be understood that the supplemental classification or ranking may be performed at other times, for example, before a new interactive media session begins or contemporaneous therewith.

The satisfaction value may be computed at 1008 based at least on the most recent interactive media event. As discussed, the satisfaction value may also reflect a combination of factors. Such a combination of factors may include, for example, the most recent interactive media event in addition to: the most recent local maximum interactive media event, the most recent local minimum interactive media event, two or more of the most recent interactive media events.

At 1010, it is determined whether, based on the satisfaction value, display of supplemental content is warranted. For example, the satisfaction value may exceed a threshold value or may drop below a low threshold value. If it is not warranted, processing returns to 1002—additional interactive media event information is received. On the other hand, if the display of supplemental content is warranted then processing continues to 1012.

At 1012 the interactive media system determines whether the satisfaction value indicates selection of positive supplemental content (1014) or negative supplemental content (1014).

At 1018, a likely local maximum satisfaction value or a likely local minimum satisfaction value is predicted. This prediction may be based on the rate of change in the satisfaction value—the rate at which the satisfaction value has been decreasing or decreasing, for example, over the most recent period of time in the game, e.g., 10-300 seconds. Based on this prediction of interactive media outcome, a prediction of the upcoming satisfaction value (e.g. a local maximum or local minimum upcoming satisfaction value).

At 1020, it is determined whether the local maximum or local minimum upcoming satisfaction value is likely to be reached within a threshold period of time, such as 2-3 minutes or 1-9 minutes, in which case, at 1022 the display of the supplemental content is delayed until the upcoming local maximum or local minimum upcoming satisfaction value is reached.

In an implementation, a user engagement metric may be determined corresponding to a user focus on an action area of the interactive media display. This is shown at 1024. At 1026, based on the engagement metric, a mode of display is selected; for example, if the user is intently concentrating on the action area, then only a basic or simplified version of the supplemental content may be displayed.

At 1028, the supplemental content may be generated for display according to the mode of display selected.

One or more actions of the methods 900-1000 may be incorporated into or combined with one or more actions of any other process or embodiments described herein. These and other methods described herein, or portions thereof, may be saved to a memory or storage (e.g., of the systems shown in FIG. 6) or locally as one or more instructions or routines, which may be executed by any suitable device or system having access to the memory or storage to implement these methods.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be affected to the particular embodiments by those of skill in the art without departing from the scope of the present application, which is defined solely by the claims appended hereto.

1. A computer implemented method comprising:
receiving user progress data based on events associated with user interaction with interactive content;
computing at least one user satisfaction value based at least on the user progress data generated for a first time period;
based on the at least one user satisfaction value, identifying a second time in the interactive content subsequent to the first time period, for inserting supplemental content; and
causing display of the supplemental content at the second time in the interactive content.

2. The method of claim 1, wherein the interactive content comprises a video game, and wherein the supplemental content is displayed in the video game by a graphical user interface.

3. The method of claim 1, wherein the interactive content is rendered via a graphical user interface provided by an extended reality (XR) device.

4. The method of claim 1, wherein the interactive content comprises a video game, and wherein the at least one user satisfaction value is determined based at least in part on at least one game event generated at least in part in reaction to user performance in the video game.

5. The method of claim 1, wherein the at least one user satisfaction value comprises a plurality of values, and the method further comprises:
determining a trend in the plurality of user satisfaction values, wherein the identifying of the second time for inserting the supplemental content is based at least on the trend.

6. The method of claim 1, wherein the interactive content comprises a video game, and the method further comprises:
predicting, based on an event in the video game, that a future game event is likely to occur;
determining that, upon the occurrence of the future game event, a second user satisfaction value is likely to be reached; and
delaying the causing the display of the supplemental content until the user satisfaction value reaches the second user satisfaction value.

7. The method of claim 1, further comprising:
based at least on determining that the user satisfaction value is below a threshold value, selecting, as the supplemental content item, comfort-themed, food-themed, or escapist supplemental content.

8. The method of claim 1, further comprising:
determining, based at least on an interactive content event, an area of user action in the interactive content; and
determining, based at least on an interactive content role of a first user, an engagement metric of the first user with the area of user action, wherein the supplemental content is caused to be displayed in a first mode, according to the determined engagement metric of the first user with the area of user action.

9. The method of claim 8, wherein the interactive content is rendered on a first device and on a second device, and further comprising:
determining, based at least on an interactive content role of a second user interacting with the interactive content via the second device, an engagement metric of the second user with the area of user action, wherein the supplemental content is caused to be displayed in a second mode on the second device according to the determined engagement metric of the second user,
wherein the display in the second mode comprises more detail or higher resolution of the supplemental content than the display on the first device of the supplemental content in the first mode.

10. The method of claim 1, further comprising:
determining, based at least on an interactive content event, a general engagement metric for user attention to the interactive content; and
delaying, based at least on the general engagement metric, the second time for the inserting of the interactive content.

11. A system comprising:
a memory; and
processing circuitry configured:
to receive user progress data based on events associated with user interaction with interactive content;
to compute at least one user satisfaction value based at least on the user progress data generated for a first time period and store in the memory the at least one user satisfaction value; based on the at least one user satisfaction value, to identify a second time in the interactive content subsequent to the first time period, for inserting supplemental content; and
to cause display of the supplemental content at the second time in the interactive content.

12. The system of claim 11, wherein the interactive content comprises a video game, and wherein the supplemental content is displayed in the video game by a graphical user interface.

13. The system of claim 11, wherein the interactive content is rendered via a graphical user interface provided by an extended reality (XR) device.

14. The system of claim 11, wherein the interactive content comprises a video game, and wherein the at least one user satisfaction value is determined based at least in part on at least one game event generated at least in part in reaction to user performance in the video game.

15. The system of claim 11, wherein the at least one user satisfaction value comprises a plurality of values, and the system is configured:
to determine a trend in the plurality of user satisfaction values, wherein the identifying of the second time for inserting the supplemental content is based at least on the trend.

16. The system of claim 11, wherein the interactive content comprises a video game, and the system is configured:
to predict, based on an event in the video game, that a future game event is likely to occur; to determine that, upon the occurrence of the future game event, a second user satisfaction value is likely to be reached; and
to delay the causing the display of the supplemental content until the user satisfaction value reaches the second user satisfaction value.

17. The system of claim 11, wherein the system is configured:
based at least on determining that the user satisfaction value is below a threshold value, to select, as the supplemental content item, comfort-themed, food-themed, or escapist supplemental content.

18. The system of claim 11, wherein the system is configured:
to determine, based at least on an interactive content event, an area of user action in the interactive content; and
to determine, based at least on an interactive content role of a first user, an engagement metric of the first user with the area of user action, wherein the supplemental content is caused to be displayed in a first mode, according to the determined engagement metric of the first user with the area of user action.

19. The system of claim 18, wherein the interactive content is rendered on a first device and on a second device, and wherein the system is configured:
to determine, based at least on an interactive content role of a second user interacting with the interactive content via the second device, an engagement metric of the second user with the area of user action, wherein the supplemental content is caused to be displayed in a second mode on the second device according to the determined engagement metric of the second user,
wherein the display in the second mode comprises more detail or higher resolution of the supplemental content than the display on the first device of the supplemental content in the first mode.

20. The system of claim 11, wherein the system is configured:
to determine, based at least on an interactive content event, a general engagement metric for user attention to the interactive content; and
to delay, based at least on the general engagement metric, the second time for the inserting of the interactive content.

21-50. (canceled)
